(19) United States
(12) Patent Application Publication
(10) Pub. No.: US 2022/0398582 A1
(43) Pub. Date: Dec. 15, 2022

(54) INFORMATION DELIVERY METHOD FOR TRANSFERRING FUND AND ELECTRONIC DEVICE

(71) Applicant: OBOOK INC., NEW TAIPEI CITY (TW)

(72) Inventors: Chun-Kai Wang, Taipei City (TW); Chung-Han Hsieh, Taipei City (TW); Chih-Yang Liu, Taipei City (TW); Wei-Te Lin, Taipei City (TW); I-Cheng Lin, Taipei City (TW); Jun-De Liao, Taoyuan City (TW); Kang-Hsien Chang, Taipei City (TW); Chun-Jen Chen, New Taipei City (TW); Pei-Hsuan Weng, New Taipei City (TW); Yi-Hsuan Lai, Taipei City (TW); Ming-Hung Lin, New Taipei City (TW); Shu-Ming Chang, Taipei City (TW); Zih-Hao Lin, Yilan County (TW)

(73) Assignee: OBOOK INC., NEW TAIPEI CITY (TW)

(21) Appl. No.: 17/344,962

(22) Filed: Jun. 11, 2021

(51) Int. Cl. G06Q 20/40; G06Q 20/38; H04L 9/32

(52) U.S. Cl. CPC G06Q 20/405; G06Q 20/401; G06Q 20/3821; H04L 9/3215; G06Q 2220/00; H04L 2209/38; H04L 2209/56

(57) ABSTRACT

An information delivery method for transferring fund is provided. The information delivery method includes receiving payment information, determining whether a transfer condition is met according to the payment information, in response to determining that the transfer condition is met, obtaining source account information of a source entity and destination account information of a destination entity in the payment information, determining a transfer path according to the source account information of the source entity and the destination account information of the destination entity, and transmitting the payment information from the source entity to the destination entity according to the transfer path.

### BACKGROUND OF THE INVENTION

### 1. Field of the Invention

The present invention relates to an information delivery method and an electronic device, and more particularly, to an information delivery method and an electronic device for transferring fund.

### 2. Description of the Prior Art

Electronic commerce (e-commerce) is the trade of products or services via the internet. Increasing penetration of the internet across the globe has led to an exponential growth of products and services getting offered on the internet. E-commerce has increased the scope of business for everyone. An e-commerce platform allows merchants or venders to create stores for selling products. A consumer may connect to the e-commerce platform via network to look for a desired product. The consumer may shop for products that they are interested on the e-commerce platform. After a transaction is completed, the consumer may pay the e-commerce platform for products. The e-commerce platform may get paid from the customer. After that, the e-commerce platform may use a payment transaction method with the payment identification code (e.g., Bank Identification Code (BIC) or SWIFT code) to direct the payment to the merchant. But, the typical payment transaction method using BIC/SWIFT code may require a long processing time for transfer. In addition, the e-commerce platform may use another payment transaction method with the virtual card number (VCN) to direct the payment to the merchant. However, the transaction fee of the typical payment transaction method using VCN may be expensive. Thus, the prior art has to be improved.

### SUMMARY OF THE INVENTION

It is therefore a primary objective of the present invention to provide an information delivery method and an electronic device for transferring fund, to solve the above-mentioned problem.

According to an embodiment of the present invention, an exemplary information delivery method for transferring fund is disclosed. The exemplary information delivery method for transferring fund comprises receiving payment information; determining whether a transfer condition is met according to the payment information; in response to determining that the transfer condition is met, obtaining source account information of a source entity and destination account information of a destination entity in the payment information; determining a transfer path according to the source account information of the source entity and the destination account information of the destination entity; and transmitting the payment information from the source entity to the destination entity according to the transfer path.

According to an embodiment of the present invention, an exemplary electronic device is disclosed. The exemplary electronic device comprises a processing circuit configured to execute instructions; and a storage device coupled to the processing circuit and storing the instructions executed by the processing circuit, wherein the instructions comprise determining whether a transfer condition is met according to the payment information; in response to determining that the transfer condition is met, obtaining source account information of a source entity and destination account information of a destination entity in the payment information; determining a transfer path according to the source account information of the source entity and the destination account information of the destination entity; and transmitting the payment information from the source entity to the destination entity according to the transfer path.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic device according to an embodiment of the present invention.

FIG. 2 is a flow diagram of a procedure of an information delivery method for transferring fund according to an embodiment of the present invention.

FIG. 3 to FIG. 6 are schematic diagrams illustrating the transfer path according to alternative embodiments of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

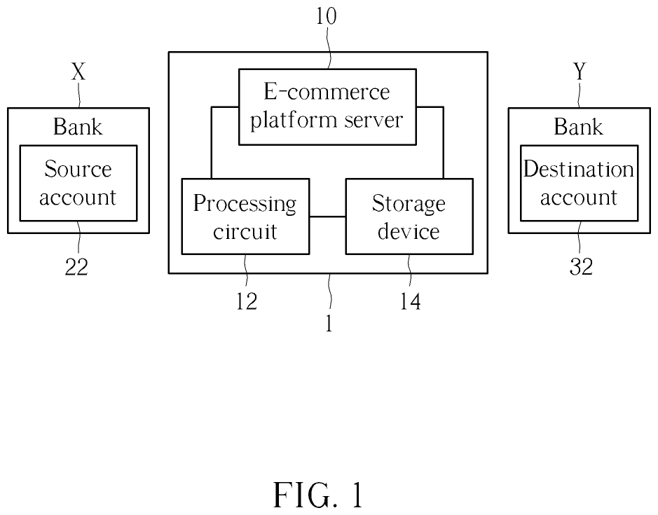

Please refer to FIG. 1, which is a schematic diagram illustrating an electronic device 1 according to an embodiment of the present invention. The electronic device 1 includes an e-commerce platform server 10, a processing circuit 12 and a storage device 14. A customer may arrive at the e-commerce platform server 10 of an e-commerce platform via network and find a merchant's product that he/she wants to purchase. The customer may buy the merchant's product on the e-commerce platform server 10 and pay for the product to the e-commerce platform. The e-commerce platform may get paid from the customer after a transaction is completed. Therefore, after the transaction has been completed, the e-commerce platform may remit the payment of the sold product to the merchant. For example, the e-commerce platform may transfer a payment amount from a source account 22 (e.g., platform account (also called bank account of the e-commerce platform)) at a bank X (source entity) to a destination account 32 (e.g., merchant account (also called bank account of the merchant platform)) at a bank Y (destination entity). The processing circuit 12 is configured to determine a transfer path according to the payment information and transmit the payment information from the bank X of the source account 22 to the bank Y of the destination account 32) according to the transfer path so as to cause the funds corresponding to the payment amount to be transferred from the source account 22 of the bank X to the destination account 32 of the bank Y.

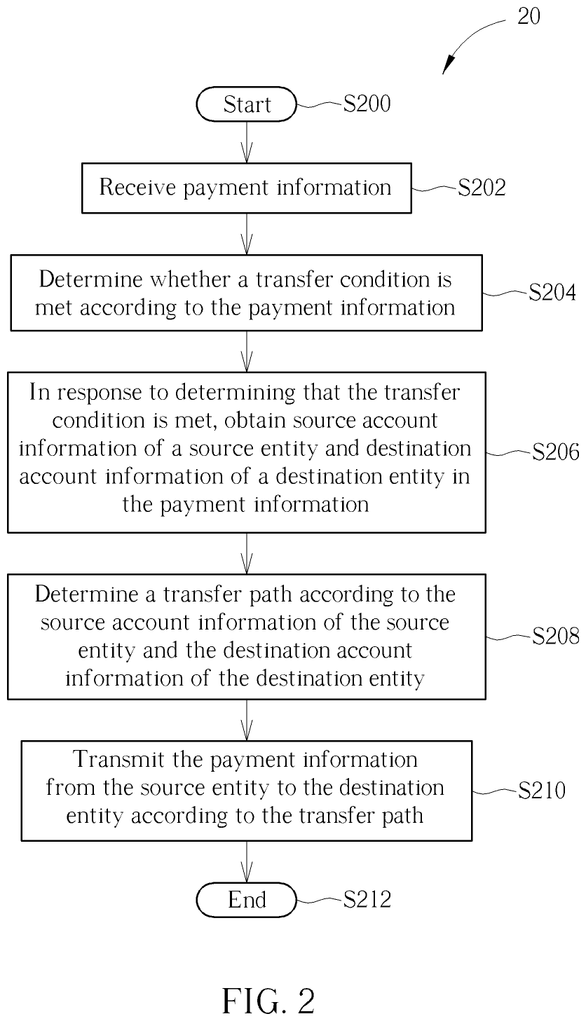

For an illustration of the operations of the electronic device 1, please refer to FIG. 2. FIG. 2 is a flow diagram of a procedure 20 of an information delivery method for transferring fund according to an embodiment of the present invention. The flowchart in FIG. 2 mainly corresponds to the operations on the electronic device 1 shown in FIG. 1. The procedure 20 includes the following steps:

Step S200: Start.

Step S202: Receive payment information.

Step S204: Determine whether a transfer condition is met according to the payment information.

Step S206: In response to determining that the transfer condition is met, obtain source account information of a source entity and destination account information of a destination entity in the payment information.

Step S208: Determine a transfer path according to the source account information of the source entity and the destination account information of the destination entity.

Step S210: Transmit the payment information from the source entity to the destination entity according to the transfer path.

Step S212: End.

According to the procedure 20, in Step S202, the processing circuit 12 is configured to receive payment information from the e-commerce platform server 10. For example, if a customer books a hotel room at an online travel agent (OTA) platform and pays for the hotel fee to the OTA platform. After the transaction has been completed, the OTA platform (e.g. e-commerce platform server 10) may transfer a payment amount of the transaction to the hotel owner through fund transferring from the source account 22 of the bank X to the destination account 32 of the bank Y. The e-commerce platform server 10 is configured to generate the payment information. The payment information may include a payment amount, source account information of a source entity, destination account information of a destination entity, appropriation indication, receipt information, order content, order number, order completion date, IP address for sending the payment information, remarks, etc. The source account information of the source entity may include information of country, bank name, source account number, source account name, etc. The destination account information of the destination entity may include information of country, bank name, destination account number, destination account name, etc. The e-commerce platform server 10 is configured to provide the payment information to the processing circuit 12.

In Step S204, after obtaining the payment information from the e-commerce platform server 10, the processing circuit is configured to determine whether a transfer condition is met according to the payment information. The processing circuit may compare the payment information with the transfer condition. When contents included in the payment information match the transfer condition, that is, the transfer condition is met, Step S206 is executed. The transfer condition may be preset. The transfer condition may include order completion, event completion, specified time, manual selection, manually trigger request for payment appropriation, but not limited thereto. For example, the transfer condition may include an indication of transferring funds as soon as receiving the payment information, an indication of transferring funds within (or after) a specific number of days after receiving the payment information, an indication of transferring funds within (or after) a specific number of days after order completion date, an indication of transferring funds on a recurring due date (e.g. 10th, 20th or 30th of every month, every 10 days, every weekend), all required information is available, appropriation indication received, etc.

For example, the transfer condition may include an indication of transferring funds after 7 days after an order completion date. The payment information includes information of an order completion date of Jan. 1, 2020. The present day is Jan. 10, 2020. The processing circuit 12 may determine whether the present day is at least 7 days after the order completion date. The processing circuit 12 may analysis the payment information to obtain the order completion date recorded in the payment information. Therefore, the processing circuit 12 may determine that the present day (i.e. Jan. 10, 2020) is 10 days after the order completion date (i.e. Jan. 1, 2020), such that the transfer condition is met and Step S206 is executed. In other words, the processing circuit 12 may determine whether a transfer condition is met according to the payment information. When the transfer condition is met, Step S206 is executed. Moreover, the amount of the transfer condition may be varied and designed in accordance with practical requirements. If several transfer conditions have been set, all the transfer conditions have to be met and then Step S206 is executed. When the transfer condition is not met in Step S204, the procedure 20 is pending and returns to step S202.

In S206, in response to determining that the transfer condition is met, the processing circuit 12 is configured to obtain source account information of the source entity and destination account information of the destination entity in the payment information. For example, the processing circuit 12 obtains platform account (i.e. source account 22) information of the bank X and merchant account (i.e. destination account 32) information of the bank Y in the payment information. The platform account information represents the platform account in the bank X. The merchant account information represents the merchant account in the bank Y.

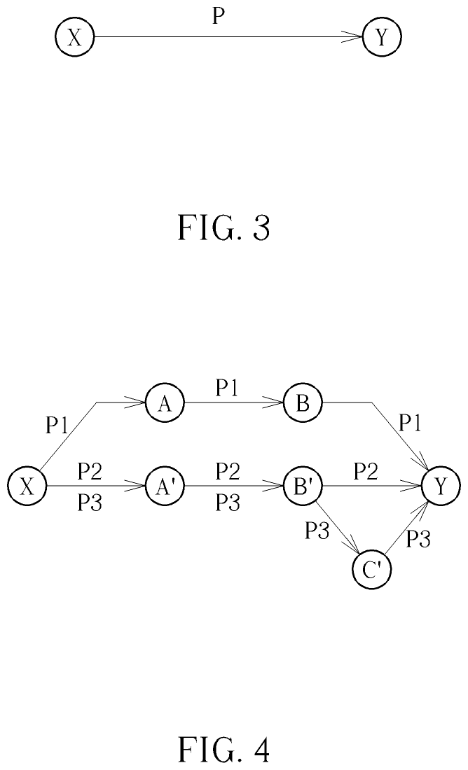

In Step S208, the processing circuit 12 determines a transfer path (also called transfer route) according to the source account information of the source entity (e.g., platform account information of the bank X) and the destination account information of the destination entity (e.g., merchant account information of the bank Y). The transfer path may include a plurality of nodes. Each node of the transfer path may represent a bank entity. The transfer path may include at least one of the source entity and the destination entity. In an embodiment, the platform account information indicates the platform account of the bank X, and the merchant account information indicates the merchant account of the bank Y. If the bank X and the bank Y are the same bank in the same country. The fund transfer from the platform account of the bank X to the merchant account of the bank Y may utilize an intra-bank transfer service. As shown in FIG. 3, the processing circuit 12 may determine a transfer path P including a node X (i.e. bank X) and a node Y (i.e. bank Y), and the node X is directly connected to the node Y.

In an embodiment, if the fund transferring from the platform account of the bank X to the merchant account of the bank Y may utilize inter-bank transfer services in different banks or involve oversea transfer services. The processing circuit 12 may determine a plurality of feasible candidate paths according to a plurality of feasible sections, a path algorithm, between the platform account of the bank X and the merchant account of the bank Y. For example, as shown in FIG. 4, the node X represents the platform account of the bank X and the node Y represents the merchant account of the bank Y. The feasible candidate paths P1, P2 and P3 are determined by the processing circuit 12. The feasible candidate path P1 includes nodes X, A, B and Y. The feasible candidate path P2 includes nodes X, A′, B′ and Y. The feasible candidate path P1 includes nodes X, A′, B′, C′ and Y. Each node of the feasible candidate path may represent a corresponding bank entity. The processing circuit 12 may determine the transfer path from the feasible candidate paths according to a predetermined selection rule corresponding to the payment information. The predetermined selection rule may be associated with at least one of the transaction fee and processing time corresponding to the feasible candidate path, but not limited there to.

For example, the processing circuit 12 may determine the transfer path from the feasible candidate paths according to the transaction fees corresponding to the feasible candidate paths. The e-commerce platform server 10 may calculate the transaction fees corresponding to the feasible candidate paths and provide information of the transaction fees corresponding to the feasible candidate paths to the processing circuit 12. After receiving the information of the transaction fees corresponding to the feasible candidate paths, the processing circuit 12 may select a feasible candidate path with the minimum total transaction fee for acting as the transfer path. As shown in FIG. 4, if the total transaction fee of banks X, A, B and Y for transferring funds corresponding to the payment amount from the platform account of the bank X to the merchant account of the bank Y (i.e. total transaction fee corresponding to the feasible candidate path P1) is 1.5 percent of the transfer amount. The total transaction fee of banks X, A′, B′ and Y for transferring funds corresponding to the payment amount from the platform account of the bank X to the merchant account of the bank Y (i.e. total transaction fee corresponding to the feasible candidate path P2) is 2 percent of the transfer amount. The total transaction fee of banks X, A′, B′, C′ and Y for transferring funds corresponding to the payment amount from the platform account of the bank X to the merchant account of the bank Y (i.e. total transaction fee corresponding to the feasible candidate path P3) is 3 percent of the transfer amount. Accordingly, the processing circuit 12 may select the feasible candidate path P1 with the minimum total transaction fee for acting as the transfer path.

For example, the processing circuit 12 may determine the transfer path from the feasible candidate paths according to the transaction fees corresponding to the feasible candidate paths and a fee threshold value. In an embodiment, the processing circuit 12 may compare a total transaction fee of each feasible candidate path with the fee threshold value. The processing circuit 12 may select a feasible candidate path having the total transaction fee less than the fee threshold value from the feasible candidate paths and determine that the selected feasible candidate path having the total transaction fee less than the fee threshold value is the transfer path. For example, the processing circuit 12 may select a feasible candidate path with the total transaction fee less than the fee threshold value for acting as the transfer path. For example, as shown in FIG. 4, the processing circuit 12 may receive information of the total transaction fee corresponding to the feasible candidate path P1 from the e-commerce platform server 10. The processing circuit 12 may compare the total transaction fee corresponding to the feasible candidate path P1 with the fee threshold value. When the total transaction fee corresponding to the feasible candidate path P1 is smaller than the fee threshold value, the processing circuit 12 may determine the feasible candidate path P1 as the transfer path. When the total transaction fee corresponding to the feasible candidate path P1 is greater than or equal to the fee threshold value, the processing circuit 12 may wait for a certain period and receive information of the total transaction fee corresponding to the feasible candidate path P2 from the e-commerce platform server 10. Similarly, the processing circuit 12 may compare the total transaction fee corresponding to the feasible candidate path P2 with the fee threshold value. When the total transaction fee corresponding to the feasible candidate path P2 is smaller than the fee threshold value, the processing circuit 12 may determine the feasible candidate path P2 as the transfer path. When the total transaction fee corresponding to the feasible candidate path P2 is greater than or equal to the fee threshold value, the processing circuit 12 may receive information of the total transaction fee corresponding to the feasible candidate path P3 from the e-commerce platform server 10 and compare the total transaction fee corresponding to the feasible candidate path P3 with the fee threshold value.

For example, the processing circuit 12 may determine the transfer path from the feasible candidate paths according to the processing time corresponding to the feasible candidate paths. The e-commerce platform server 10 may calculate the processing time corresponding to the feasible candidate paths and provide information of the processing time corresponding to the feasible candidate paths to the processing circuit 12. After receiving the information of the processing time corresponding to the feasible candidate paths, the processing circuit 12 may select a feasible candidate path with the shortest total processing time for acting as the transfer path.

In Step S210, the processing circuit 12 transmits the payment information from the source entity to the destination entity according to the transfer path so as to cause the funds corresponding to the payment amount to be transferred from the source account of the source entity to the destination account of the destination entity. For example, the processing circuit transmits the payment information from the bank X of the source account 22 to the bank Y of the destination account 32 according to the transfer path. Therefore, during processing the fund transfer corresponding to the payment information, the funds corresponding to the payment information may be transferred from the source account 22 of the bank X into the destination account 32 of the bank Y through the predetermined path since the payment information has been transmitted from the source account 22 of the bank X into the destination account 32 of the bank Y.

In an alternative embodiment, in Step S208, the transfer path may include a predetermined path and the destination entity (e.g., bank Y) may be not on the predetermined path. The fund transferring on the predetermined path may be implemented by a bank transfer payment network service, such as Ripple, SBI remit, Visa, MasterCard. The processing circuit 12 may determine a back end connection path according to an end node of the predetermined path and the destination account information of the destination entity (e.g., information of destination account 32 of the bank Y). A start end of the back end connection path may be end node of the predetermined path. The end of the back end connection path may be the destination entity (e.g., bank Y). Moreover, in Step S210, the processing circuit 12 may transmit the payment information and an indication, indicating that the transfer path includes the predetermined path, to a start node of the predetermined path, so that the payment information may be transmitted from the start node of the predetermined path to the end node of the predetermined path. The processing circuit 12 may transmit an indication to each node of the back end connection path and an end node of the predetermined path respectively. The indication to be transmitted to each node may include next hop information for each node. As such, each node (bank entity) receiving the corresponding indication may identify and admit the next node (next bank entity) to be transferred according to the next hop information. Further, when receiving the payment information, the each node may transmit the payment information to the next node since the next node has been identified, so that during processing the fund transfer corresponding to the payment information, the each node (bank entity) receiving the corresponding indication may transfer fund corresponding to the payment information to the next bank entity according to the payment information and the next hop information. Therefore, during processing the fund transfer corresponding to the payment information, the funds corresponding to the payment information may be transferred from the source account of the source entity (e.g., source account 22 at the bank X) into the destination account of the destination entity (e.g., destination account 32 at the bank Y) through the predetermined path and back end connection path since the payment information has been transmitted from the source entity to the destination entity through the predetermined path and the back end connection path.

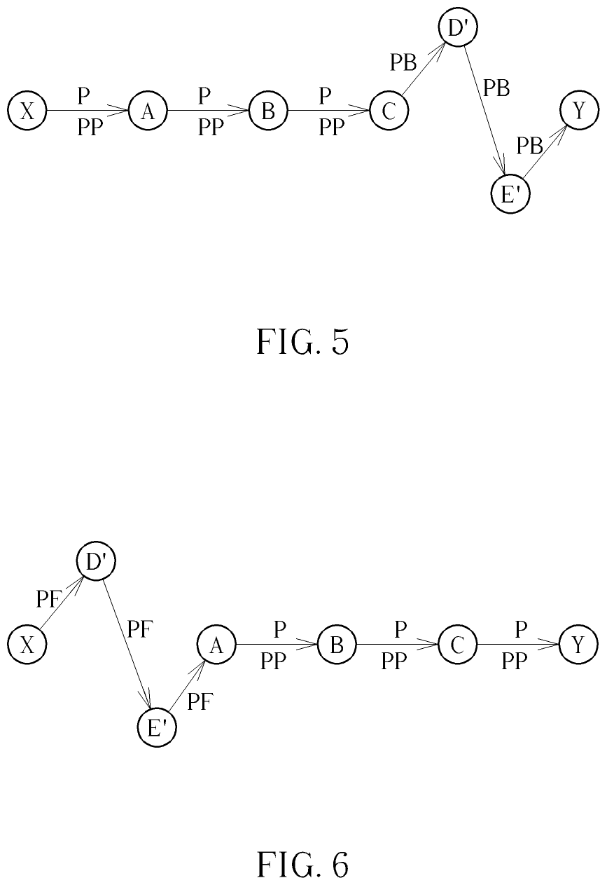

For example, as shown in FIG. 5, the node X represents the platform account of the bank X and the node Y represents the merchant account of the bank Y. The transfer path P includes a predetermined path PP. The predetermined path PP includes nodes X, A, B and C. The fund transferring on the predetermined path PP may be implemented by a bank transfer payment network service, such as Ripple, SBI remit, Visa, MasterCard. As shown, in FIG. 5, the predetermined path PP does not include the node Y. That is, the node Y (i.e. bank Y) is not on the predetermined path PP. Under such a situation, the processing circuit 12 determines a back end connection path PB according to the end node (i.e. node C) of the predetermined path PP and the merchant account of the bank Y. The back end connection path PB includes nodes C, D′, E′ and Y. The processing circuit 12 transmits an indication, indicating that the next node to be transferred is node D′, to the node C. The processing circuit 12 transmits an indication, indicating that the next node to be transferred is node E′, to the node D′. The processing circuit 12 transmits an indication, indicating that the next node to be transferred is node Y, to the node E′. Moreover, the processing circuit 12 transmits the payment information and an indication, indicating that the transfer path P includes the predetermined path PP, to the node X. The payment information may be transmitted from the node X to the node C according to the predetermined path PP. After receiving the payment information, the node C transmits the payment information to the node D′ according to the indication transmitted from the processing circuit 12. Such as this, the node D′ transmits the payment information to the node E′ and the node E′ transmits the payment information to the node Y. Therefore, during processing the fund transfer corresponding to the payment information, the funds corresponding to the payment information may be transferred from the platform account at the bank X into the merchant account of the bank Y through the predetermined path PP and the back end connection path PB

In an alternative embodiment, in Step S208, the transfer path may include a predetermined path and the destination entity may be not on the predetermined path. The fund transferring on the predetermined path may be implemented by a bank transfer payment network service. The processing circuit 12 may determine a back end connection path according to an end node of the predetermined path and the destination account information of the destination entity. A start end of the back end connection path may be the end node of the predetermined path. The end of the back end connection path may be the destination entity (e.g., bank Y). Further, in Step S210, the processing circuit 12 may transmit the payment information and an indication, indicating that the transfer path includes the predetermined path, to a start node of the predetermined path, so that the payment information may be transmitted from the start node of the predetermined path to the end node of the predetermined path. The processing circuit 12 may transmit an indication indicating the back end connection path to the end node of the predetermined path, so that the payment information may be transmitted from the end node of the predetermined path to the end node of the back end connection path. Therefore, during processing the fund transfer corresponding to the payment information, the funds corresponding to the payment information may be transferred from the source account of the source entity (e.g., source account 22 at the bank X) into the destination account of the destination entity (e.g., destination account 32 at the bank Y) through the predetermined path and back end connection path since the payment information has been transmitted from the source entity to the destination entity through the predetermined path and the back end connection path.

For example, please further refer to FIG. 5. The fund transferring on the predetermined path PP may be implemented by a bank transfer payment network service, such as Ripple, SBI remit, Visa, MasterCard. The processing circuit 12 transmits the payment information and an indication, indicating that the transfer path P includes the predetermined path PP, to the node X. The payment information may be transmitted from the node X to the node C according to the predetermined path PP. The processing circuit 12 transmits an indication indicating the back end connection path PB, to the node C (the end node of the predetermined path PP). The payment information may be transmitted from the node C to the node Y according to the back end connection path PB. During processing the fund transfer corresponding to the payment information, the funds corresponding to the payment information may be transferred from the platform account at the bank X into the merchant account of the bank Y through the predetermined path PP and the back end connection path PB.

In an alternative embodiment, in Step S208, the transfer path may include a predetermined path and the source entity (e.g., bank X) may be not on the predetermined path. The fund transferring on the predetermined path may be implemented by a bank transfer payment network service, such as Ripple, SBI remit, Visa, MasterCard. The processing circuit 12 may determine a front end connection path according to a start node of the predetermined path and the source account information of the source entity (e.g., information of source account 22 of the bank X). A start end of the front end connection path may be the source entity (e.g., bank X). An end of the front end connection path may be the start node of the predetermined path. In Step S210, The processing circuit 12 may transmit the payment information to the start node of the front end connection path. The processing circuit 12 may transmit an indication to each node of the front end connection path and the start node of the predetermined path respectively. The indication to be transmitted to each node may include next hop information for each node. As such, each node (bank entity) receiving the corresponding indication may identify and admit the next node (next bank entity) to be transferred according to the next hop information. When receiving the payment information, the each node may transmit the payment information to the next node since the next node has been identified, so that during processing the fund transfer corresponding to the payment information, the each node (bank entity) receiving the corresponding indication may transfer fund corresponding to the payment information to the next bank entity according to the payment information and the next hop information. As such the payment information may be transmitted from the start node of the front end connection path to the start node of the predetermined path. The processing circuit 12 may transmit an indication, indicating that the transfer path includes the predetermined path, to a start node of the predetermined path, so that the payment information may be transmitted from the start node of the predetermined path to the end node of the predetermined path. Therefore, during processing the fund transfer corresponding to the payment information, the funds corresponding to the payment information may be transferred from the source account of the destination entity into the destination account of the destination entity through front end connection path and the predetermined path since the payment information has been transmitted from the source entity to the destination entity through the front end connection path and the predetermined path.

For example, as shown in FIG. 6, the node X represents the platform account of the bank X and the node Y represents the merchant account of the bank Y. The transfer path P includes a predetermined path PP. The predetermined path PP includes nodes A, B, C and Y. The fund transferring on the predetermined path PP may be implemented by a bank transfer payment network service, such as Ripple, SBI remit, Visa, MasterCard. As shown, in FIG. 6, the predetermined path PP does not include the node X. That is, the node X (i.e. bank X) is not on the predetermined path PP. Under such a situation, the processing circuit 12 determines a front end connection path PF according to the start node (i.e. node A) of the predetermined path PP and the platform account of the bank X. The front end connection path PF includes nodes X, D′, E′ and A. The processing circuit 12 transmits an indication, indicating that the next node to be transferred is node D′, to the node X. The processing circuit 12 transmits an indication, indicating that the next node to be transferred is node E′, to the node D′. The processing circuit 12 transmits an indication, indicating that the next node to be transferred is node A, to the node E′. Moreover, the processing circuit 12 transmits the payment information and an indication, indicating that the transfer path P includes the predetermined path PP, to the node X. After receiving the payment information, the node X transmits the payment information to the node D′ according to the indication transmitted from the processing circuit 12. Such as this, the node D′ transmits the payment information to the node E′ and the node E′ transmits the payment information to the node A. Moreover, the processing circuit 12 transmits an indication, indicating that the transfer path P includes the predetermined path PP, to the node A. The payment information may be transmitted from the node A to the node Y according to the predetermined path PP. Therefore, during processing the fund transfer corresponding to the payment information, the funds corresponding to the payment information may be transferred from the platform account at the bank X into the merchant account of the bank Y through the front end connection path PF and the predetermined path PP.

In an alternative embodiment, in Step S208, the transfer path may include a predetermined path and the source entity may be not on the predetermined path. The fund transferring on the predetermined path may be implemented by a bank transfer payment network service. The processing circuit 12 may determine a front end connection path according to a start node of the predetermined path and the source account information of the source entity (e.g., information of source account 22 of the bank X). A start end of the front end connection path may be the source entity (e.g., bank X). An end of the front end connection path may be the start node of the predetermined path. Further, in Step S210, the processing circuit 12 may transmit the payment information and an indication, indicating the front end connection path, to a start node of the front end connection path, so that the payment information may be transmitted from the start node of the front end connection path to the end node of the front end connection path. The processing circuit 12 may transmit an indication indicating the predetermined path to a start node of the predetermined path (i.e. the end node of the front end connection path), so that the payment information may be transmitted from the start node of the predetermined path to the end node of the predetermined path.

For example, please further refer to FIG. 6. The fund transferring on the predetermined path PP may be implemented by a bank transfer payment network service, such as Ripple, SBI remit, Visa, MasterCard. The processing circuit 12 transmits the payment information and an indication indicating the front end connection path PF to the node X. The payment information may be transmitted from the node X to the node A according to the front end connection path PF. The processing circuit 12 transmits an indication indicating the predetermined path PP to the node A (the end node of the front end connection path PF). The payment information may be transmitted from the node A to the node Y according to the predetermined path PP. During processing the fund transfer corresponding to the payment information, the funds corresponding to the payment information may be transferred from the platform account at the bank X into the merchant account of the bank Y through the front end connection path PF and the predetermined path PP.

The electronic device 1 may be applied in a blockchain network. The blockchain network may include a main chain. The blockchain network may include a main chain and branch chains. Each node of the transfer path, the predetermined path, the front end connection path, the back end connection path may be applied in a blockchain network. For each node of the transfer path, the predetermined path, the front end connection path, the back end connection path, when the each node receives the payment information, a reception event may be added and recorded in a ledger and the reception event may be broadcasted to each node in the blockchain network. For each node, when the each node transmits the payment information to a next node, a transmission event may be added and recorded in a ledger and the transmission event may be broadcasted to each node in the blockchain network. The destination entity may be in a blockchain network. When destination entity receives the payment information, a successful transfer event may be added and recorded in the ledger and the successful transfer event may be broadcasted to each node in the blockchain network.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system or combination thereof. An example of the means may be the electronic device 1. Examples of hardware can include analog, digital and/or mixed circuits known as microcircuit, microchip, or silicon chip. For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof. Examples of the software may include set(s) of codes, set(s) of instructions and/or set(s) of functions retained (e.g., stored) in a storage device, e.g., a non-transitory computer-readable medium. The non-transitory computer-readable storage medium may include read-only memory (ROM), flash memory, random access memory (RAM), subscriber identity module (SIM), hard disk, floppy diskette, or CD-ROM/DVD-ROM/BD-ROM, but not limited thereto. Examples of the electronic system may include a system on chip (SoC), system in package (SiP), a computer on module (CoM), a computer program product, an apparatus, a mobile phone, a laptop, a tablet computer, an electronic book or a portable computer system and the test equipment 104.

Any of the abovementioned procedures and examples above may be compiled into program codes or instructions that are stored in a non-transitory storage device. For example, the storage device 14 may store program codes or instructions, accessed and executed by the processing circuit 12. The processing circuit 12 may read and execute the program codes or the instructions stored in the storage device 14 for realizing the abovementioned functions. Moreover, the electronic device 1 may be any computer device which includes the processing circuit and the storage device 14 and is capable of executing the program codes or the instructions of the abovementioned procedures and examples for realizing the abovementioned functions.

In summary, the embodiments of the present invention may verify transfer condition and derive the appropriate transfer path for various application situations, so as to direct operations of the overall payment between the e-commerce platform and the merchant and also to facilitate the payment transfer from the platform account to the merchant account, thus, reducing the actual transaction fee and providing agile transfer experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information delivery method for transferring fund comprising:
receiving payment information;
determining whether a transfer condition is met according to the payment information;
in response to determining that the transfer condition is met, obtaining source account information of a source entity and destination account information of a destination entity in the payment information;
determining a transfer path according to the source account information of the source entity and the destination account information of the destination entity; and
transmitting the payment information from the source entity to the destination entity according to the transfer path.

2. The information delivery method of claim 1, wherein the step of determining the transfer path according to the source account information of the source entity and the destination account information of the destination entity comprises:
determining a plurality of feasible candidate paths according to a plurality of feasible sections, a path algorithm, the source account information and the destination account information; and
determining the transfer path from the plurality of feasible candidate paths according to a predetermined selection rule corresponding to the payment information, wherein the transfer path includes at least one of the source entity and the destination entity.

3. The information delivery method of claim 2, wherein predetermined selection rule is associated with at least one of transaction fees and processing time corresponding to the plurality of feasible candidate paths.

4. The information delivery method of claim 3, wherein predetermined selection rule is associated with the transaction fees of the feasible candidate and a fee threshold value, the step of determining the transfer path from the plurality of feasible candidate paths according to the predetermined selection rule corresponding to the payment information comprises:
comparing a total transaction fee of each feasible candidate path with the fee threshold value; and
selecting a feasible candidate path having the total transaction fee less than the fee threshold value from the feasible candidate paths and determining that the selected feasible candidate path has the total transaction fee less than the fee threshold value as the transfer path.

5. The information delivery method of claim 1, wherein the transfer path includes a predetermined path, the destination entity is not on the predetermined path, the information delivery method further comprising:
determining a back end connection path according to an end node of the predetermined path and the destination account information of the destination entity;
transmitting an indication to each node of the back end connection path and the end node of the predetermined path respectively, wherein the indication to be transmitted to each node comprises next hop information for each node; and
transmitting the payment information from the source entity to the destination entity through the predetermined path and the back end connection path.

6. The information delivery method of claim 1, wherein the transfer path includes a predetermined path, the destination entity is not on the predetermined path, the information delivery method further comprising:
determining a back end connection path according to an end node of the predetermined path and the destination account information of the destination entity;
transmitting an indication indicating the back end connection path to the end node of the predetermined path; and
transmitting the payment information from the source entity to the destination entity through the predetermined path and the back end connection path.

7. The information delivery method of claim 1, wherein the transfer path includes a predetermined path, the source entity is not on the predetermined path, the information delivery method further comprising:
determining a front end connection path according to the source account information of the source entity and a start node of the predetermined path;
transmitting an indication to each node of the front end connection path and the start node of the predetermined path respectively, wherein the indication to be transmitted to each node comprises next hop information for each node; and
transmitting the payment information from the source entity to the destination entity through the front end connection path and the predetermined path.

8. The information delivery method of claim 1, wherein the transfer path includes a predetermined path, the source entity is not on the predetermined path, the information delivery method further comprising:
determining a front end connection path according to the source account information of the source entity and a start node of the predetermined path;
transmitting an indication indicating the front end connection path to a start node of the front end connection path; and
transmitting the payment information from the source entity to the destination entity through the front end connection path and the predetermined path.

9. The information delivery method of claim 1, wherein the transfer path comprises a plurality of nodes, the plurality of nodes being in a blockchain network, wherein the step of transmitting the payment information from the source entity to the destination entity according to the transfer path comprising:
sequentially transmitting the payment information to the plurality of nodes of the transfer path,
for each node, recording a reception event in a ledger when receiving the payment information by each node, and broadcasting the reception event to each node in the blockchain network; and
for each node, recording a transmission event in the ledger when transmitting the payment information to a next node by each node, and broadcasting the transmission event to each node in the blockchain network.

10. The information delivery method of claim 1, wherein the destination entity being in a blockchain network, the information delivery method further comprising
recording a successful transfer event in a ledger when receiving the payment information by the destination entity, and broadcasting the successful transfer event to each node in the blockchain network.

11. An electronic device, comprising:
a processing circuit configured to execute instructions; and
a storage device coupled to the processing circuit and storing the instructions executed by the processing circuit, wherein the instructions comprise:
determining whether a transfer condition is met according to the payment information;
in response to determining that the transfer condition is met, obtaining source account information of a source entity and destination account information of a destination entity in the payment information;
determining a transfer path according to the source account information of the source entity and the destination account information of the destination entity; and
transmitting the payment information from the source entity to the destination entity according to the transfer path.

12. The electronic device of claim 11, wherein the instructions further comprise:
determining a plurality of feasible candidate paths according to a plurality of feasible sections, a path algorithm, the source account information and the destination account information; and
determining the transfer path from the plurality of feasible candidate paths according to a predetermined selection rule corresponding to the payment information, wherein the transfer path includes at least one of the source entity and the destination entity.

13. The electronic device of claim 12, wherein predetermined selection rule is associated with at least one of transaction fees and processing time corresponding to the plurality of feasible candidate paths.

14. The electronic device of claim 13, wherein predetermined selection rule is associated with the transaction fees of the feasible candidate and a fee threshold value, the instructions further comprise:
comparing a total transaction fee of each feasible candidate path with the fee threshold value; and
selecting a feasible candidate path having the total transaction fee less than the fee threshold value from the feasible candidate paths and determining that the selected feasible candidate path has the total transaction fee less than the fee threshold value as the transfer path.

15. The electronic device of claim 11, wherein the instructions further comprise:
determining a back end connection path according to an end node of the predetermined path and the destination account information of the destination entity;
transmitting an indication to each node of the back end connection path and the end node of the predetermined path respectively, wherein the indication to be transmitted to each node comprises next hop information for each node; and
transmitting the payment information from the source entity to the destination entity through the predetermined path and the back end connection path.

16. The electronic device of claim 11, wherein the instructions further comprise:
determining a back end connection path according to an end node of the predetermined path and the destination account information of the destination entity;
transmitting an indication indicating the back end connection path to the end node of the predetermined path; and
transmitting the payment information from the source entity to the destination entity through the predetermined path and the back end connection path.

17. The electronic device of claim 11, wherein the instructions further comprise:
determining a front end connection path according to the source account information of the source entity and a start node of the predetermined path;
transmitting an indication to each node of the front end connection path and the start node of the predetermined path respectively, wherein the indication to be transmitted to each node comprises next hop information for each node; and
transmitting the payment information from the source entity to the destination entity through the front end connection path and the predetermined path.

18. The electronic device of claim 11, wherein the instructions further comprise:
determining a front end connection path according to the source account information of the source entity and a start node of the predetermined path;
transmitting an indication indicating the front end connection path to a start node of the front end connection path; and
transmitting the payment information from the source entity to the destination entity through the front end connection path and the predetermined path.

19. The electronic device of claim 11, wherein the transfer path comprises a plurality of nodes, the plurality of nodes being in a blockchain network, wherein the instructions further comprise:
sequentially transmitting the payment information to the plurality of nodes of the transfer path,
for each node, recording a reception event in a ledger when receiving the payment information by each node, and broadcasting the reception event to each node in the blockchain network; and
for each node, recording a transmission event in the ledger when transmitting the payment information to a next node by each node, and broadcasting the transmission event to each node in the blockchain network.

20. The electronic device of claim 11, wherein the destination entity being in a blockchain network, wherein the instructions further comprise:
recording a successful transfer event in a ledger when receiving the payment information by the destination entity, and broadcasting the successful transfer event to each node in the blockchain network.
